(19) United States
(12) Patent Application Publication
(10) Pub. No.: US 2021/0342901 A1
(43) Pub. Date: Nov. 4, 2021

(54) SYSTEMS AND METHODS FOR MACHINE-ASSISTED DOCUMENT INPUT

(71) Applicant: JPMORGAN CHASE BANK, N.A., New York, NY (US)

(72) Inventors: Jiangling WANG, Brooklyn, NY (US); Song Ting CENG, Brooklyn, NY (US); Hong JI, Dix Hills, NY (US); Somnath CHOUDHURI, Newark, DE (US); Michael K. O'LEARY, Garden City Park, NY (US); Riti SINGHAL, Sayreville, NJ (US); Sandeep KOLLA, McKinney, TX (US); Syed Mohammed Abbas UBAISE, Frisco, TX (US); Michael HORGAN, Wilmington, DE (US)

(21) Appl. No.: 17/243,289

(22) Filed: Apr. 28, 2021

Related U.S. Application Data
(60) Provisional application No. 63/017,549, filed on Apr. 29, 2020.

(51) Int. Cl. G06Q 30/04; G06N 20/00; G06Q 10/10; G06Q 30/02; G06Q 40/00; G06F 40/205; G06F 40/295

(52) U.S. Cl. CPC G06Q 30/04; G06N 20/00; G06Q 10/107; G06F 40/295; G06Q 40/12; G06F 40/205; G06Q 30/0201

(57) ABSTRACT

Systems and methods for machine-assisted document input are disclosed. In one embodiment, a method may include a data extraction application executed by a computer processor: receiving an image of a document/email; generating a transcript of the document/email, wherein the transcript comprises a plurality of text groups from the document/email and a location for each text group in the document/email; identifying a vendor associated with the document/email based on contents of one of the text groups and/or one of the locations of the one of one of the text groups; retrieving a vendor-specific machine learning model for the vendor; associating each of the plurality of locations in the document/email with a billing field using the vendor-specific machine learning model; extracting each of the text groups into one of the billing fields based on the association; and transmitting the billing fields with the extracted data to a user electronic device.

### RELATED APPLICATIONS

This application claims priority to, and the benefit of, U.S. Patent Application Ser. No. 63/017,549, filed Apr. 29, 2021, the disclosure of which is hereby incorporated, by reference, in its entirety.

### BACKGROUND OF THE INVENTION

### 1. Field of the Invention

Embodiments relate to systems and methods for machine-assisted document input, and, more specifically, to analyzing a document or email such as, for example, a billing statement, and extracting values within the document or email.

### 2. Description of the Related Art

Users may receive statements from multiple vendors and those statements may vary in format. A statement may be a bill or invoice issued by a vendor, such as a utility company, a medical provider, an Internet service provider, a cell phone provider, etc.

The location of different fields, such as a vendor name and address, a customer name and address, a customer account number, an amount due, a due date, etc. may vary from one statement to another. Users may submit payments by manually entering information into a portal or an application. This may be a time-consuming process as a user must cross-reference a statement to identify information and manually enter it into a portal or application to submit payment.

### SUMMARY OF THE INVENTION

Systems and methods for machine-assisted document input are disclosed. In one embodiment, a method for machine-assisted document input may include: (1) receiving, at a data extraction application executed by a computer processor, an image of a document or email, wherein the document or email comprises a billing statement; (2) generating, by the data extraction application, a transcript of the document or email, wherein the transcript comprises a plurality of text groups from the document or email and a location for each text group in the document or email; (3) identifying, by the data extraction application, a vendor associated with the document or email based on contents of one of the text groups and/or one of the locations of the one of one of the text groups; (4) retrieving, by the data extraction application, a vendor-specific machine learning model for the vendor; (5) associating, by the data extraction application, each of the plurality of locations in the document or email with a billing field using the vendor-specific machine learning model; (6) extracting, by the data extraction application, each of the text groups into one of the billing fields based on the association; and (7) transmitting, by the data extraction application, the billing fields with the extracted data to a user electronic device.

In one embodiment, the data extraction application may identify the vendor using a trained vendor identification machine learning model.

In one embodiment, the vendor-specific machine learning model may be trained using a plurality of documents or emails for the vendor.

In one embodiment, the billing fields may include a vendor name field, a vendor address billing field, an account number billing field, and/or an amount billing field.

In one embodiment, the method may further include applying, by the data extraction application, a pattern matching algorithm to the text groups in the transcript to identify the billing fields.

In one embodiment, the pattern matching algorithm may use regular expressions to identify the billing fields based on a pattern of the text groups and the locations of the text groups in the document or email.

In one embodiment, the method may further include classifying, by the data extraction application, contents of one of the text groups using a classification rule.

According to another embodiment, a method for machine-assisted document input may include: (1) receiving, at a data extraction application executed by a computer processor, an image of a document or email, wherein the document or email comprises a billing statement; (2) generating, by the data extraction application, a transcript of the document or email, wherein the transcript comprises a plurality of text groups from the document or email and a location for each text group in the document or email; (3) retrieving, by the data extraction application, a vendor-agnostic machine learning model; (4) associating, by the data extraction application, each of the plurality of locations in the document or email with a billing field using the vendor-agnostic machine learning model; (5) extracting, by the data extraction application, each of the text groups into one of the billing fields based on the association; and (6) transmitting, by the data extraction application, the billing fields with the extracted data to a user electronic device.

In one embodiment, the vendor-agnostic model may be trained using a plurality of documents or emails from a plurality of vendors.

In one embodiment, the billing fields may include a vendor name field, a vendor address billing field, an account number billing field, and/or an amount billing field.

In one embodiment, the method may further include applying, by the data extraction application, a pattern matching algorithm to the text groups in the transcript to identify the billing fields based on a pattern of the text groups and the locations of the text groups in the document or email.

In one embodiment, the pattern matching algorithm may use regular expressions to identify the billing fields.

In one embodiment, the method may further include classifying, by the data extraction application, contents of one of the text groups using a classification rule.

According to another embodiment, a method for machine-assisted document input may include: (1) receiving, at a data extraction application executed by a computer processor, a document or email, wherein the document or email may include a billing statement; (2) generating, by the data extraction application, a transcript of the document or email, wherein the transcript comprises a plurality of text groups from the document or email and a location for each text group in the document or email; (3) applying, by the data extraction application, a pattern matching algorithm to the text groups in the transcript to identify billing fields based on a pattern of the text groups and locations in the document or email; (4) extracting, by the data extraction application, each of the text groups into one of the billing fields based on the pattern; and (5) transmitting, by the data extraction application, the billing fields with the extracted data to a user electronic device.

In one embodiment, the billing fields may include a vendor name field, a vendor address billing field, an account number billing field, and/or an amount billing field.

In one embodiment, the pattern matching algorithm may use regular expressions to identify the billing fields.

In one embodiment, the method may further include classifying, by the data extraction application, contents of one of the text groups using a classification rule.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a networked environment according to various embodiments.

FIG. 2 is a drawing of a document according to various embodiments.

FIG. 3 depicts the organization of various machine learning models according to various embodiments

FIG. 4 is a flowchart illustrating a method for machine-assisted document input according to various embodiments.

FIG. 5 is a flowchart illustrating an example of using an email input in a method for machine-assisted document input according to various embodiments.

FIG. 6 is a schematic block diagram of an example of a computing system in a networked environment according to various embodiments.

### DETAILED DESCRIPTION OF PREFERRED EMBODIMENTS

Exemplary embodiments will now be described in order to illustrate various features. The embodiments described herein are not intended to be limiting as to the scope, but rather are intended to provide examples of the components, use, and operation of the invention.

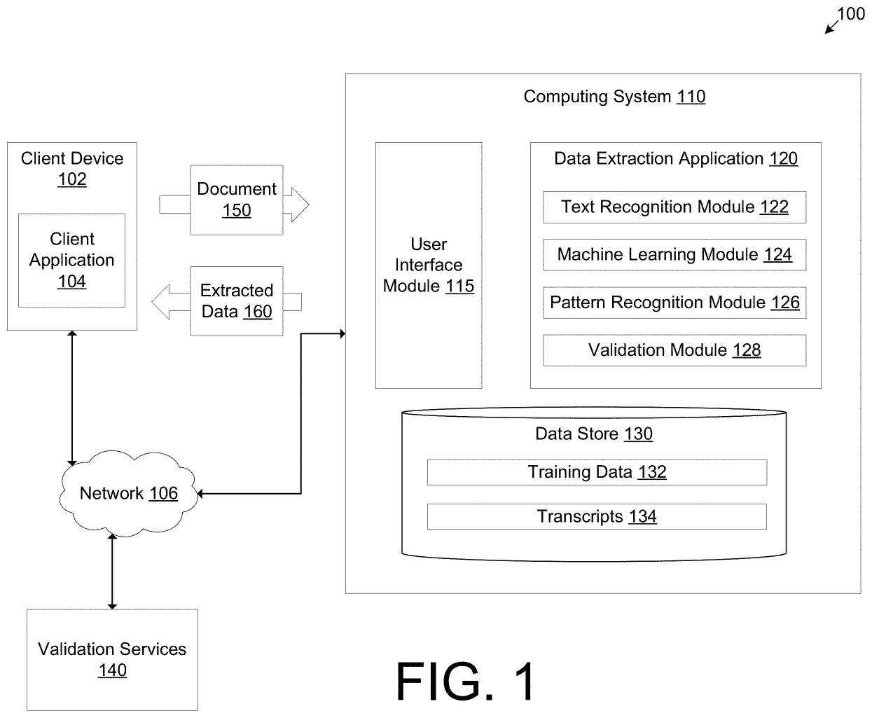

FIG. 1 depicts a networked environment 100 according to various embodiments. The networked environment 100 may include one or more client devices 102. A client device 102 may be, for example, a smartphone, a laptop computer, a personal computer, a mobile device, an Internet of Things (IoT) device, or any other suitable computing device. The client device 102 may be connected to or otherwise include a scanner, camera, or other sensor to capture an image. The client device 102 may execute a client application 104, such as a web browser or dedicated mobile application. The client application 104 may provide a portal to access the functionality of server-based applications, such as, for example, a payment service. A payment service may allow a user to input information to pay a bill. A payment service may receive information from a user such as, for example, a payment amount (e.g., a dollar amount), payee information (e.g., information about the recipient including name, address, etc.), instructions for conducting a payment or series of payments (e.g., a date for when to submit the payment), authorization to submit a payment, or any other information for paying a payee.

The client device 102 may be connected to a network 106 such as the Internet, intranets, extranets, wide area networks (WANs), local area networks (LANs), wired networks, wireless networks, or other suitable networks, etc., or any combination of two or more such networks.

The networked environment 100 may further include a computing system 110 that may comprise hardware and/or software. The computing system 110 may comprise, for example, a server computer or any other system providing computing capability. Alternatively, the computing system 110 may employ a plurality of computing devices that may be arranged, for example, in one or more server banks or computer banks or other arrangements. Such computing devices may be located in a single installation or may be distributed among many different geographical locations. For example, the computing system 110 may include a plurality of computing devices that together may comprise a hosted computing resource, a grid computing resource and/or any other distributed computing arrangement. In some cases, the computing system 110 may correspond to an elastic computing resource where the allotted capacity of processing, network, storage, or other computing-related resources may vary over time. The computing system 110 may implement one or more virtual machines that use the resources of the computing system 110. Various software components may be executed on one or more virtual machines.

Various applications and/or other functionality may be executed in the computing system 110 according to various embodiments. For example, the computing system 110 may include a user interface module 115 and a data extraction application 120. The user interface module 115 may be configured to receive data from a client device 102 and forward it to the data extraction application 120.

The data extraction application 120 may be a server-side application that interfaces with client devices 102 to receive documents, extract relevant field-values, and forward the field values to the client device 102 as an output. For example, the data extraction application 120 may obtain an image of a billing statement, identify values such as, for example, the name of the vendor, an account number, an amount billed, a statement date, the identity of the service provider, and other relevant information. The data extraction application 120 may provide those values to a server-side payment service, which may forward the values to the client application 104.

The data extraction application 120 may include a text recognition module 122. The text recognition module is configured to receive image data and convert the image into a transcript comprising words and their respective location or coordinates in the image. Example locations or coordinates may include top left, top right, center, bottom, etc. Any suitable manner of identifying the location of the text in the image may be used as is necessary and/or desired. The text recognition module may store the transcript in a data store (not shown).

In some embodiments, the text recognition module 122 may execute outside of the data extraction application 120. For example, the text recognition module 122 may be accessed as an external service by the data extraction application 120 using an Application Programming Interface (API). The text recognition module 122 may use optical character recognition (OCR) or other algorithms to convert image data into text data.

The data extraction application 120 may include a machine learning module 124. The machine learning module 124 may include a plurality of machine learning models that are configured using training data. In some embodiments, the machine learning model 124 may implement a clustering related algorithm such as, for example, K-Means, Mean-Shift, density-based spatial clustering applications with noise (DBSCAN), or Fuzzy C-Means. In some embodiments, the machine learning model 124 may implement a classification related algorithm such as, for example, Naïve Bayes, (k-nearest neighbors) K-NN), support vector machine (SVM), Decision Trees, or Logistic Regression. In some embodiments, the machine learning model 124 may implement a deep learning algorithm such as, for example, a convolutional neural network (CNN), recurrent neural network (RNN), a multilayer perception (MLP), or a generative adversarial network (GAN).

The data extraction application 120 may also include a pattern recognition module 126. A pattern recognition module 126 may include hard-coded rules (e.g., regular expressions, or “RegExs”) that provide for the identification of relevant data.

The data extraction application 120 may also include a validation module 128. The validation module 128 may include one or more APIs that may plug into third-party validation services to validate or otherwise format data into standard formats.

The computing system 110 may also include a data store 130. Various data may be stored in the data store 130 or other memory that may be accessible to the computing system 110. The data store 130 may represent one or more data stores 130. The data store 130 may include one or more databases. The data store 130 may be used to store data that is processed or handled by the data extraction application 120 or data that may be processed or handled by other applications executing in the computing system 110.

The data store 130 may include training data 132, transcripts 134, and other data as is necessary and/or desired. The training data 132 may include labeled datasets for configuring models within the machine learning module 124. The training data 132 may include manually tagged datasets for implementing supervised learning.

Transcripts 134 may include strings or lines of characters that represent the text expressed in an image. A transcript may include the words, characters, or symbols expressed by image along with the coordinates or location of those words, characters, or symbols. The transcript 134 may be generated by the text recognition module 122 and used by the data extraction application 120.

The network environment may also include validation services 140. A validation service 140 may be, for example, a paid service or an open source service that receives an address input and generates a standardized version of the address as an output. The validation service 140 may be used by API calls made by the validation module 128.

The networked environment 100 allows the client device 102 to transmit a document 150 over the network 106 to the user interface module 115. The document may be an image of a statement (e.g., billing statement). The data extraction application 120 may analyze the document 150 and extract relevant data needed as payment inputs. For example, the data extraction application 120 may convert the document into a transcript 134 using a text recognition module 122. The data extraction application 120 may apply machine learning processes using a machine learning module 124 to extract data from the document. In some embodiments, the data extraction application 120 may use a pattern recognition module 126 to assist or otherwise complement the data extraction process. Certain extracted data such as, for example, addresses, may be validated using a third-party validation service 140.

The extract data may be provided to a payment service that is executing in the computing system. In some embodiments, the data extraction application 120 may be a module within a payment service. The extracted data 160 is then transmitted to the client application 104. For example, the extracted data 160 may be used to auto-populate fields presented by a client application 104. Those fields may relate to inputs for making a payment.

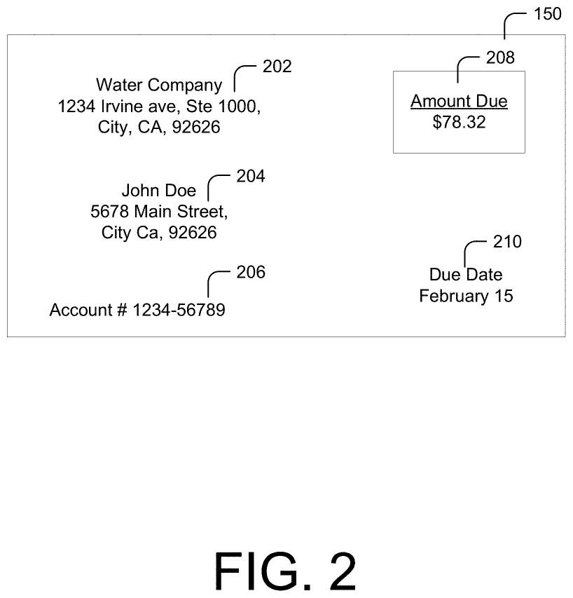

FIG. 2 is an exemplary illustration of a document 150 according to various embodiments. The document 150 may be generated by scanning or taking a picture of a paper version of the document. In this respect, the document 150 is a digital document that may be formatted in an image format or other document format such that it represents a paper version.

The document 150 may represent a billing statement to solicit a payment from the user. The user may use an image capture device on a client device 102 to generate the document 150 of FIG. 2.

The document may include a variety of fields, including a vendor's name/address 202, the user's name/address 204, an account number 206, a payment amount 208, a due date 210, etc. Other information may be provided as is necessary and/or desired. A vendor may provide a service and bill the user for using the service. To make the payment reflected in the document 150, the user may use a payment service accessible by the client device 102 to submit the payment amount 208. Embodiments may analyze the document 150, extract the values of the various relevant fields in the document (e.g., the payment amount, the account number, the vendor's name, etc.) and send the extracted data to the user. The extracted data may be auto populated in various fields of the client application 104, where the client application 104 is used to submit a payment using the payment service.

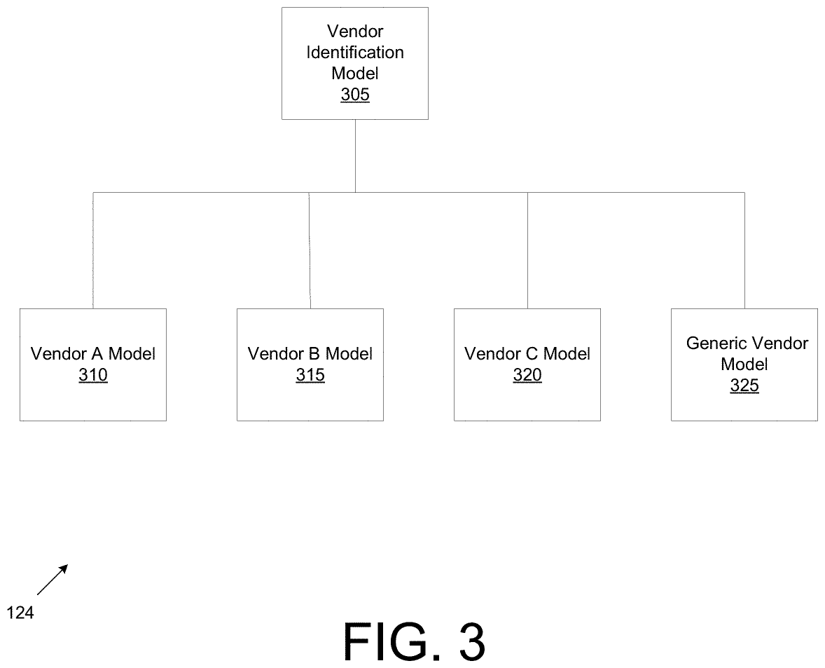

FIG. 3 depicts the organization of various machine learning models according to an embodiment. For example, machine learning module 124 may use a two-stage process that uses a trained machine learning module to first identify the vendor that issued a document 150, and then perform an analysis that is specific to the vendor. This approach may allow for greater accuracy in properly extracting data from a document.

For example, the vendor identification model 305 may be trained to determine the identity of the vendor based on a dataset of labeled documents (e.g., training data 132). The dataset may include multiple documents 150, each from Vendor A, Vendor B, and Vendor C, along with a label indicating the identity of the respective vendor. Thus, in runtime, a document 150 may be classified as belonging to Vendor A, Vendor B, Vendor C, or known.

As the second stage, once the vendor is identified, a machine learning module corresponding to the vendor (e.g., Vendor A model 310, Vendor B model 315, and Vendor C model 320) may be selected. For unknown vendors, a generic, default model (e.g., generic vendor model 325) that is agnostic to the vendor may be selected. To train each of these vendor-specific models 310, 315, 320, training data 132 may be used to label various field values in statements issued by the specific vendor. While this example uses three known vendors, any number of vendors may be accommodated by the machine learning module 124.

The unknown vendor model 325 may be trained using the data set from known vendors (e.g., the training data for the vendor A model 310, vendor B model 315, vendor C model 320). In addition, the unknown vendor model 325 may be trained using previously collected data that has been labeled and annotated. For example, the unknown vendor model 325 may be trained on corrected results provided by customers via a user interface to improve the unknown vendor model 325.

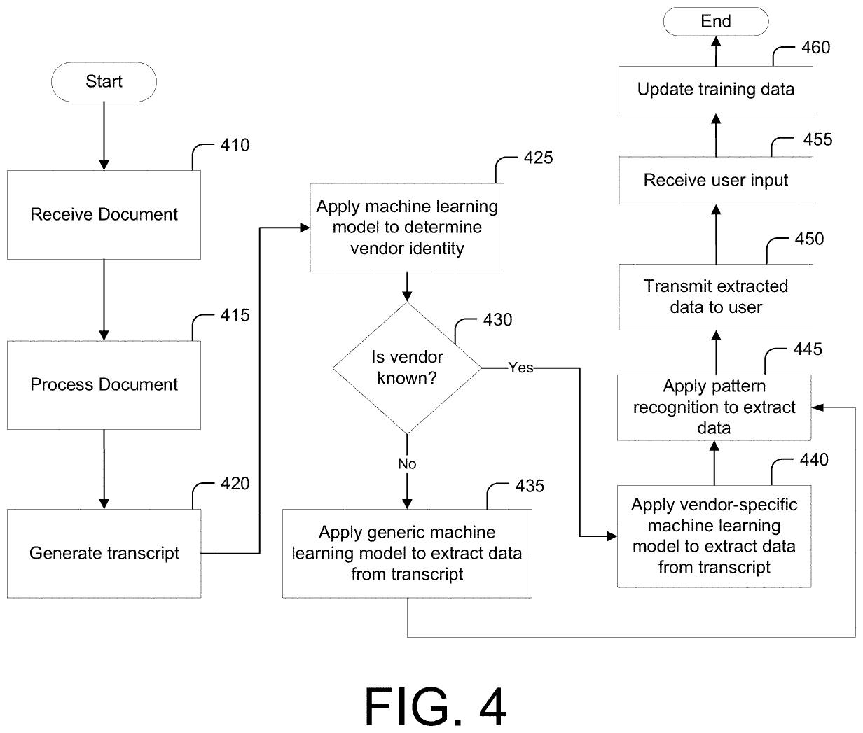

FIG. 4 is a flowchart depicting a method for machine-assisted document input according to various embodiments. The flowchart of FIG. 4 provides an example of the many different types of functional arrangements that may be employed to implement the operation of the portion of the computing system 110 as described herein. The method may be performed by a data extraction application, such as for example, the data extraction application 120 of FIG. 1.

In step 410, the data extraction application may receive a document, such as a billing statement, as an image. In one embodiment, the document may be received from a client application executing in a client device. The document may be formatted according to an image format file or other document format such as, for example, a portable document format. The image may be generated at a client device in response to a user taking a picture of the document. The image may contain various values corresponding to different fields (e.g., name of vendor, address, payment amount, due date, etc.).

In step 415, the data extraction application may process the document. For example, the data extraction application may perform image quality control, convert the image into grayscale, perform image compression, and evaluate whether an image is non-compliant (e.g., low resolution, improperly scanned, etc.). The data extraction application may also convert the document into a predetermined image format as necessary.

In one embodiment, a text block detection process may optionally be performed. For example, if the vendor is known, the data extraction application may identify blocks of text according to the template for the vendor. The template may specify position information related to what features to extract.

In step 420, the data extraction application may generate a transcript from the processed document. For example, the data extraction application may use a text recognition module to identify the text in the processed document, resulting in a transcript containing the text of the document. In one embodiment, the text may be in text groups based on the location of the text in the document. The transcript may further include metadata, such as the coordinates or location of the text came (e.g., top, middle, bottom, left, right, etc.).

In step 425, the data extraction application may apply a trained vendor identification machine learning model to the transcript to identify the vendor. For example, the trained vendor identification machine learning model may be trained to identify the vendor from the transcript of the document. In one embodiment, the machine learning model may identify the vendor based on vendor information in the transcript of the document, such as the vendor name, address, or other identifier. In another embodiment, the machine learning model may identify the vendor based on a format of the document. Any suitable manner of identifying the vendor may be used as is necessary and/or desired.

In step 430, the data extraction application may determine whether the vendor identified in step 425 is a known vendor, such as a vendor for which a vendor-specific machine learning model is available.

If, in step 430, the vendor is not a known vendor, then in step 435, the data extraction application may use a trained machine learning model to associate each of the locations or coordinates in the document with a billing field. In one embodiment, the generic machine learning model may be trained to identify generic patterns in documents, such as generic locations or coordinates for the vendor name, vendor address, account number, due date, amount due, etc. The generic machine learning model may also be trained to identify generic patterns or formats for addresses, account numbers, amounts, etc. Using the trained generic machine learning model, the data extraction application may associate coordinates or locations in the document with certain billing fields (e.g., vendor name, vendor address, account number, amount due, due date, etc.) and may extract the data from the transcript and associate it with the appropriate billing field.

If, in step 430, the vendor is a known vendor, in step 440, the data extraction application may use a trained vendor-specific machine learning model to associate each of the locations or coordinates in the document with a billing field. For example, using the trained vendor-specific machine learning model, the data extraction application may associate coordinates or locations in the document with a billing field (e.g., vendor name, vendor address, account number, amount due, due date, etc.) and associate the data from the transcript with the appropriate billing field.

In step 445, the data extraction application may apply pattern recognition to extract data from the document. The use of pattern recognition serves as a hybrid approach that combines machine learning techniques with the use of rules or RegExs. For example, to extract an address value from an address field using pattern recognition, a pattern recognition module of the data extraction application may use a combination of state and zip codes appearing in the transcript. Example rules may include: (1) to identify a state, search for two letter state name abbreviations or any states with full names; and (2) to identify zip codes: search for 5, 9 or 5-4 digit codes located to the right of the state. RegExs may be used to identify the zip code.

In one embodiment, depending on the accuracy of the pattern matching in extracting data from the document, steps 435 and 440 may be optional.

The data extraction application may select the line where each state-zip code combination is identified and then extract the contents appearing a predetermined number of lines above each state-zip code line. For example, because an address may typically occupy three or four lines, the data extraction application may extract three or four lines appearing above the state-zip code line. The contents appearing above each state-zip code line may be referred to as a candidate address. The data extraction application may use an address standardizer program to convert each address value into a standard format. The address standardizer may be provided as a validation service that is accessible using an API.

As another example, the data extraction application may use one or more rules for classifying the address to determine if the address is for the recipient or for the provider. Such rules, include, for example, whether the address contains a “P.O. Box.”, whether the address appears next to a landmark such as “remit,” or “mail to,”, or “payable.” Such landmarks provide context as to whether the address is for the provider or recipient.

At 450, the data extraction application may transmit extracted data and the associated billing fields to the user. The extracted data represents values of fields identified in the document that was received (e.g., in step 410). The extracted values may be auto populated in billing fields or other user interface forms provided by the client device. The client device may prompt the user to confirm or allow the user to edit the auto-populated fields.

In step 455, the data extraction application may receive user input, such as user feedback. The user input may be used to confirm that the extracted values are correct, to correct or adjust the extracted values, etc.

In step 460, the data extraction application may update the training data. In this respect, the user input to either confirm or change the extracted values compounds the training data with additional training data to improve the training model.

The functionality associated with receiving user input and updating the training data allows customers to annotate and build training data to continuously improve the accuracy of the machine learning module. To illustrate by way of example, assume that there are four candidate results for exacting an address value. Based on the machine learning module, the first candidate result has a 70% likelihood of being correct, the second candidate result has a 65% likelihood of being correct, the third candidate result has a 40% likelihood of being correct, and the fourth candidate result has a 30% likelihood of being correct. The machine learning module selects the first candidate result because it has the likelihood of being correct, however, the second candidate result is correct in actuality. A user provides user input correcting the result to be the second candidate result. The training data is then updated to improve the machine learning module. The next user who processes a similar document may then see improved results. For example, the second candidate result has a 90% likelihood of being correct, the first candidate result has a 65% likelihood of being correct, the third candidate result has a 40% likelihood of being correct, and the fourth candidate result has a 30% likelihood of being correct. The second candidate result would be provided to the next user, and assuming that is correct, it would be confirmed by the next user.

In some embodiments, the user interface for soliciting user input to confirm or change the extracted data may include the field name of the extracted data (e.g., address a set of candidate extracted data values (e.g., the specific addresses), a corresponding ranking score for each extracted value (e.g., the percentage probability of correctness determined by the machine learning module). This could be applied to each field type of the extracted values to solicit user input.

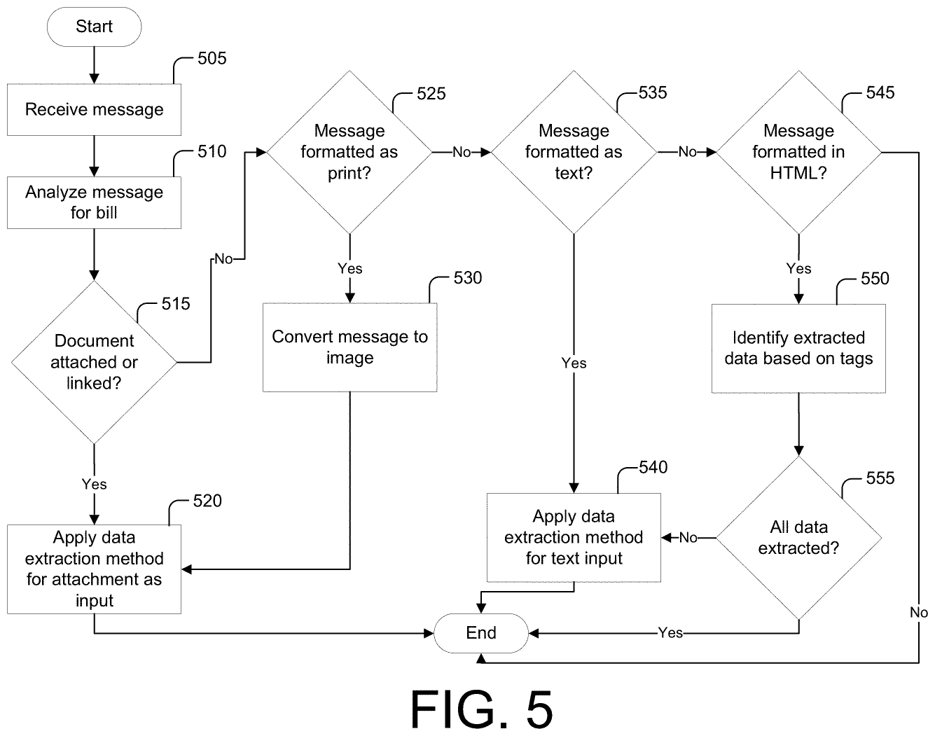

FIG. 5 is a flowchart depicting the use of a message input in a method for machine-assisted document input according to various embodiments. The flowchart of FIG. 5 provides an example of the many different types of functional arrangements that may be employed to implement the operation of the portion of the computing system 110 as described herein. The method may be performed by a data extraction application, such as for example, the data extraction application 120 of FIG. 1.

While the method of FIG. 4 provided an example of processing a document, the method of FIG. 5 provides an embodiment, where the document is an email.

In step 505, the data extraction application may receive a message, such as an email, a text message, etc. The message may contain a statement for a bill to be paid, a link to a bill, etc. A user may instruct vendors to send bills to a predetermined email address so that the data extraction application automatically receives emails from vendors, or to send bill notifications to a predetermined SMS address. The message may also be forwarded to the data extraction application by the user.

In step 510, the data extraction application may analyze the message to detect a bill. For example, the data extraction application may evaluate whether the message contains an attachment, where the attachment is a document that contains the bill. The data extraction application may evaluate whether the message contains the contents of the bill in a print format so that the email is optimized to be printed by a printer. The data extraction application may evaluate whether the message is formatted as text that contains the contents of the bill. The data extraction application may evaluate whether the message is in an HTML format using HTML tags to identify the contents of the message.

In one embodiment, the data extraction application may identify that the message includes a link to the bill.

In step 515, if the message contains an attachment having a document that is a bill, or contains a link to a bill, then, the flowchart proceeds to step 520. In step 520, the data extraction application applies a data extraction method where the attachment is the input. For example, step 520 may be performed by at least portions of the method of FIG. 4 beginning with handling the attachment as the document of step 410.

In step 525, if the message is formatted as print, then, the flowchart proceeds to item 530. In step 530, the data extraction application converts the message to an image. This may be a print to image operation. Thereafter, in step 520, the image is handled as the document of item 410.

In step 535, if the email is formatted as text, then, the flowchart proceeds to item 540. In step 540, the data extraction application may apply a data extraction method for the text input. For example, item 540 may be performed by at least portions of the method of FIG. 4 beginning with handling the text as the transcript of step 420.

In step 545, if the message is formatted as HTML, then, the flowchart proceeds to item 550. In step 550, the data extraction application may identify the extracted data based on HTML tags. For example, if the message uses HTML tags such as “address”, “payment amount” or other relevant fields, the HTML tags may specify the location of the values that should be extracted.

In step 555, the data extraction application may determine if all data is extracted. For example, the data extraction application checks if a minimum number of field values are extracted from the HTML-formatted email. If some important or necessarily field values are not extracted in step 550, (such as, for example, a payment amount), then the flowchart proceeds to item 540. Otherwise, the data extraction is complete.

Although the flowchart of FIGS. 4 and 5 show specific orders of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The components carrying out the operations of the flowcharts may also comprise software or code that can be embodied in any non-transitory computer-readable medium for use by or in connection with an instruction execution system such as, for example, a processor in a computing system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

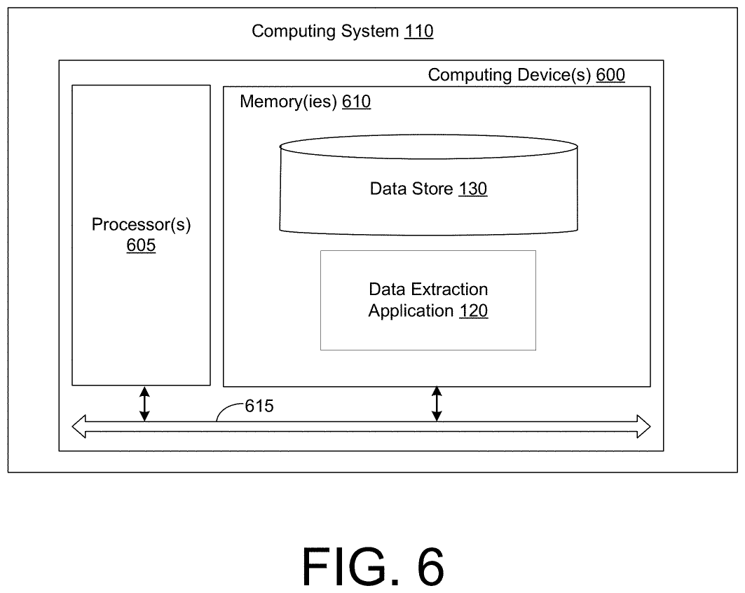

FIG. 6 is a schematic block diagram of an example of a computing system in a networked environment according to various embodiments. The computing system 110 may comprise one or more computing devices 600. A computing device 600 may be a remote server. The computing device 600 includes at least one processor circuit, for example a processor 605, and memory 610, both of which may be coupled to a local interface 615 or bus. The local interface 615 may comprise a data bus with an accompanying address/control bus or other bus structure.

Data and several components may be stored in memory 610. The data and several components may be accessed and/or executable by the processor 605. The data extraction application 120 may be stored/loaded in memory 610 and executed by the processor 605. Other applications may be stored in memory 610 and may be executable by processor 605. Any component discussed herein may be implemented in the form of software, any one of a number of programming languages may be employed, for example, C, C++, C#, Objective C, Java®, JavaScript®, Perl, PHP, Visual Basic®, Python®, Ruby, or other programming languages.

Several software components may be stored in memory 610 and may be executable by processor 605. The term “executable” may be described as a program file that may be in a form that may ultimately be run by processor 605. Examples of executable programs may be, a compiled program that may be translated into machine code in a format that may be loaded into a random access portion of memory 610 and run by processor 605, source code that may be expressed in proper format such as object code that may be capable of being loaded into a random access portion of memory 610 and executed by processor 605, or source code that may be interpreted by another executable program to generate instructions in a random access portion of memory 610 to be executed by processor 605, and the like. An executable program may be stored in any portion or component of memory 610, for example, random access memory (RAM), read-only memory (ROM), hard drive, solid-state drive, USB flash drive, memory card, optical disc such as compact disc (CD) or digital versatile disc (DVD), floppy disk, magnetic tape, or any other memory components.

The memory 610 may be defined as including both volatile and nonvolatile memory and data storage components. Volatile components may be those that do not retain data values upon loss of power. Nonvolatile components may be those that retain data upon a loss of power. Memory 610 may comprise random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. Embodiments, RANI may comprise static random-access memory (SRAM), dynamic random access memory (DRAM), or magnetic random access memory (MRAM) and other such devices. Embodiments, ROM may comprise a programmable read-only memory (PROM), an erasable programmable read-only memory (EPROM), an electrically erasable programmable read-only memory (EEPROM), or other like memory device.

The processor 605 may represent multiple processors 605 and/or multiple processor cores and memory 610 may represent multiple memories 610 that may operate in parallel processing circuits, respectively. The local interface 615 may be an appropriate network that facilitates communication between any two of the multiple processors 605, between any processor 605 and any of the memories 610, or between any two of the memories 610, and the like. The local interface 615 may comprise additional systems designed to coordinate this communication, for example, performing load balancing. The processor 605 may be of electrical or other available construction.

The memory 610 stores various software programs. These software programs may be embodied in software or code executed by hardware as discussed above, as an alternative, the same may also be embodied in dedicated hardware or a combination of software/hardware and dedicated hardware. If embodied in dedicated hardware, each may be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, and the like. Technologies may generally be well known by those skilled in the art and, consequently, are not described in detail herein.

The operations described herein may be implemented as software stored in computer-readable medium. Computer-readable medium may comprise many physical media, for example, magnetic, optical, or semiconductor media. Examples of a suitable computer-readable medium may include, but are not limited to, magnetic tapes, magnetic floppy diskettes, magnetic hard drives, memory cards, solid-state drives, USB flash drives, or optical discs. Embodiments, computer-readable medium may be a random-access memory (RAM), for example, static random-access memory (SRAM) and dynamic random access memory (DRAM), or magnetic random access memory (MRAM). Computer-readable medium may be a read-only memory (ROM), a programmable read-only memory (PROM), an erasable programmable read-only memory (EPROM), an electrically erasable programmable read-only memory (EEPROM), or other type of memory device.

Any logic or application described herein, including the data extraction application 120 may be implemented and structured in a variety of ways. One or more applications described may be implemented as modules or components of a single application. One or more applications described herein may be executed in shared or separate computing devices or a combination thereof. For example, the software application described herein may execute in the same computing device 600, or in multiple computing devices.

Disjunctive language such as the phrase “at least one of X, Y, or Z,” unless specifically stated otherwise, is understood with the context as used in general to present that an item, term, and the like, may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments described herein are possible examples of implementations set forth for a clear understanding of the principles of the disclosure. Many variations and modifications may be made to the above-described embodiment(s) without departing substantially from the spirit and principles of the disclosure.

What is claimed is:

1. A method for machine-assisted document input, comprising:
receiving, at a data extraction application executed by a computer processor, a document or email, wherein the document or email comprises a billing statement;
generating, by the data extraction application, a transcript of the document or email, wherein the transcript comprises a plurality of text groups from the document or email and a location for each text group in the document or email;
identifying, by the data extraction application, a vendor associated with the document or email based on contents of one of the text groups and/or one of the locations of the one of one of the text groups;
retrieving, by the data extraction application, a vendor-specific machine learning model for the vendor;
associating, by the data extraction application, each of the plurality of locations in the document or email with a billing field using the vendor-specific machine learning model;
extracting, by the data extraction application, each of the text groups into one of the billing fields based on the association; and
transmitting, by the data extraction application, the billing fields with the extracted data to a user electronic device.

2. The method of claim 1, wherein the data extraction application identifies the vendor using a trained vendor identification machine learning model.

3. The method of claim 1, wherein the vendor-specific machine learning model is trained using a plurality of documents or emails for the vendor.

4. The method of claim 1, wherein the billing fields comprise a vendor name field, a vendor address billing field, an account number billing field, and an amount billing field.

5. The method of claim 1, further comprising:
applying, by the data extraction application, a pattern matching algorithm to the text groups in the transcript to identify the billing fields.

6. The method of claim 5, wherein the pattern matching algorithm uses regular expressions to identify the billing fields based on a pattern of the text groups and the locations of the text groups in the document or email.

7. The method of claim 1, further comprising:
classifying, by the data extraction application, contents of one of the text groups using a classification rule.

8. The method of claim 1, wherein the document or email comprises an image.

9. A method for machine-assisted document input, comprising:
receiving, at a data extraction application executed by a computer processor, a document or email, wherein the document or email comprises a billing statement;
generating, by the data extraction application, a transcript of the document or email, wherein the transcript comprises a plurality of text groups from the document or email and a location for each text group in the document or email;
retrieving, by the data extraction application, a vendor-agnostic machine learning model;
associating, by the data extraction application, each of the plurality of locations in the document or email with a billing field using the vendor-agnostic machine learning model;
extracting, by the data extraction application, each of the text groups into one of the billing fields based on the association; and
transmitting, by the data extraction application, the billing fields with the extracted data to a user electronic device.

10. The method of claim 9, wherein the vendor-agnostic model is trained using a plurality of documents or emails from a plurality of vendors.

11. The method of claim 9, wherein the billing fields comprise a vendor name field, a vendor address billing field, an account number billing field, and an amount billing field.

12. The method of claim 9, further comprising:
applying, by the data extraction application, a pattern matching algorithm to the text groups in the transcript to identify the billing fields based on a pattern of the text groups and the locations of the text groups in the document or email.

13. The method of claim 12, wherein the pattern matching algorithm uses regular expressions to identify the billing fields.

14. The method of claim 9, further comprising:
classifying, by the data extraction application, contents of one of the text groups using a classification rule.

15. The method of claim 9, wherein the document or email comprises an image.

16. A method for machine-assisted document input, comprising:
receiving, at a data extraction application executed by a computer processor, a document or email, wherein the document or email comprises a billing statement;
generating, by the data extraction application, a transcript of the document or email, wherein the transcript comprises a plurality of text groups from the document or email and a location for each text group in the document or email;
applying, by the data extraction application, a pattern matching algorithm to the text groups in the transcript to identify billing fields based on a pattern of the text groups and locations in the document or email;
extracting, by the data extraction application, each of the text groups into one of the billing fields based on the pattern; and
transmitting, by the data extraction application, the billing fields with the extracted data to a user electronic device.

17. The method of claim 16, wherein the billing fields comprise a vendor name field, a vendor address billing field, an account number billing field, and an amount billing field.

18. The method of claim 16, wherein the pattern matching algorithm uses regular expressions to identify the billing fields.

19. The method of claim 16, further comprising:
classifying, by the data extraction application, contents of one of the text groups using a classification rule.

20. The method of claim 16, wherein the document or email comprises an image.
